(19) United States
(12) Patent Application Publication
(10) Pub. No.: US 2011/0122776 A1
(43) Pub. Date: May 26, 2011

(54) Method, Apparatus, and Computer Program Product for Traffic Simulation Tool for Networks

(75) Inventors: Carl Jacob, Keyport, NJ (US); Stephen J. Griesmer, Westfield, NJ (US)

(73) Assignee: AT&T INTELLECTUAL PROPERTY, Reno, NV (US)

(21) Appl. No.: 12/625,959

(22) Filed: Nov. 25, 2009

(51) Int. Cl. H04L 12/26

(52) U.S. Cl. 370/250

(57) ABSTRACT

Method, apparatus, and computer products are provided for creating a network design and simulating communication traffic over the network design on a computer. Input of network elements is received, and the network elements are operatively connected by links to form a network design. Each network element and each link include parameters representative of software and hardware. Input is received of a test condition for a simulation of communication traffic over the network design. The test includes the type of communication traffic, the amount of communication traffic, and the times at which the communication traffic occurs. The computer executes the simulation of the test condition for the network design to determine a survivability for the network elements and the links connecting the network elements. The computer executes an impact analysis on the output of the simulation to determine if there are excessive loads on the network elements and links.

### BACKGROUND

Exemplary embodiments relate to, but are not limited to, a tool for simulating message and/or call traffic in a network environment.

As networks become more complex, the performance of the network may become hard to predict. The inter-operation of new and old technologies and different vendors may prove difficult in determining the validity of a network. Also, vendor recommended settings can result in unexpected and undesirable results after being deployed in a production environment if not tested. These issues can result in networking faults in which customer affecting conditions may appear after the initial planning and design phase and may require immediate assessment to resolve.

### BRIEF SUMMARY

Exemplary embodiments include a method implemented on a computer for creating a network design and simulating communication traffic over the network design. Input of network elements is received, and the network elements are operatively connected by links to form a network design. Each network element and each link include parameters representative of software and hardware. Input is received of a test condition for a simulation of communication traffic over the network design. The test condition includes the type of communication traffic, the amount of communication traffic, and the times at which the communication traffic occurs. The computer executes the simulation of the test condition for the network design to determine a survivability for the network elements and the links connecting the network elements. The computer executes an impact analysis on the output of the simulation to determine if there are excessive loads on the network elements and links.

Other systems, methods, apparatus, and/or computer program products according to embodiments will be or become apparent to one with skill in the art upon review of the following drawings and detailed description. It is intended that all such additional systems, methods, apparatus, and/or computer program products be included within this description, be within the scope of the exemplary embodiments, and be protected by the accompanying claims.

### BRIEF DESCRIPTION OF DRAWINGS

Referring now to the drawings wherein like elements are numbered alike in the several FIGURES:

FIG. 1 illustrates a block diagram in accordance with exemplary embodiments;

FIG. 2 illustrates a flow chart for creating a network topology (design) for a voice over Internet protocol (VoIP) network in accordance with exemplary embodiments;

FIG. 3 illustrates a flow chart of simulating a network design in accordance with exemplary embodiments;

FIG. 4 illustrates an example of a graphical user interface (GUI) in accordance with exemplary embodiments; and

FIG. 5 illustrates a method for creating and simulating communication traffic over a network design in accordance with exemplary embodiments.

The detailed description explains exemplary embodiments, together with features, by way of example with reference to the drawings.

### DETAILED DESCRIPTION OF EXEMPLARY EMBODIMENTS

In the following detailed description, numerous specific details are set forth in order to provide a thorough understanding of exemplary embodiments. However, it will be understood by those skilled in the art that the present disclosure may be practiced without these specific details. In other instances, well-known methods, procedures, components, and circuits have not been described in detail so as not to obscure the present disclosure.

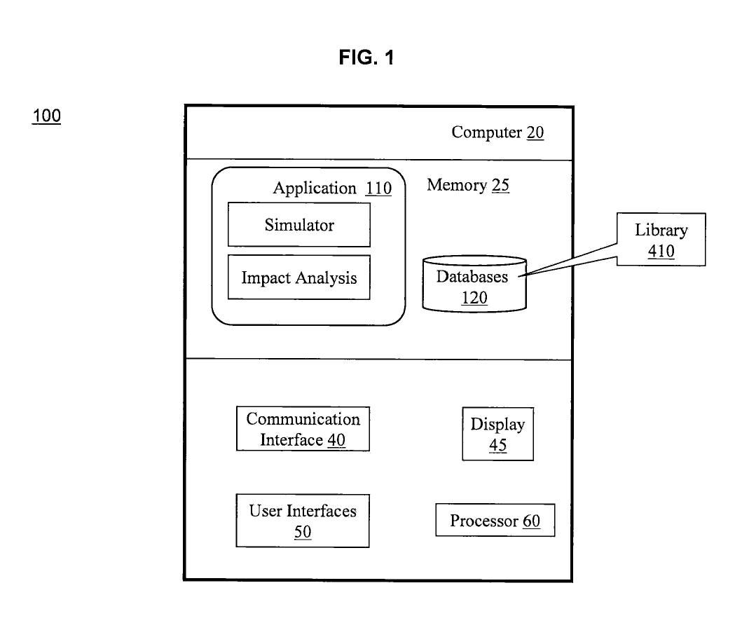

Now turning to FIG. 1, FIG. 1 illustrates a block diagram 100 in accordance with exemplary embodiments.

A computer 20 may include memory 25, which includes a computer readable storage medium. The computer 20 may include one or more applications 110 that are configured with computer executable instructions to implement exemplary embodiments discussed herein. The application 110 may include and/or represent numerous software components for carrying out the operations and functions of exemplary embodiments.

The memory 25 may include one or more databases 120. The computer 20 may include a communication interface 40, such as the software and hardware understood by one skilled in the art, for communicating over a network. The computer 20 may include a display 45, user interfaces 50, and processors 60. The user interfaces 50 may include, e.g., a mouse, track ball, pointing devices, keyboard, etc., for inputting commands and operating the computer 20.

The computer 20 may include, for example and without limitation, mobile telephones, smart telephones, soft telephones, personal digital assistants, set top boxes (STB), televisions (TV), game consoles, MP3 players, communication devices, computing devices, and servers.

In accordance with exemplary embodiments, the application 110 comprises the logic and is operative to be implemented as a tool capable of simulating message traffic in, e.g., a layer 4+ network environment such as but not limited to for example the transport layer, session layer, presentation layer, and application layer. The tool of the application 110 is operative to accept a user-defined network topology and test cases, and the application 110 is configured to use that information to help determine if the network design created by the user has any vulnerabilities, suggest network improvements, and validate the expected performance of the network design.

The application 110 is configured to simulate communication traffic over, e.g., a user created network design and determine the validity of the network design input by a user. The network design input into the application 110 by the user may include both parameters of network elements that represent new and old network devices from different vendors. The parameters are technical specifications of the network elements of the network design so that the simulation of the application 110 can be run according to the test condition.

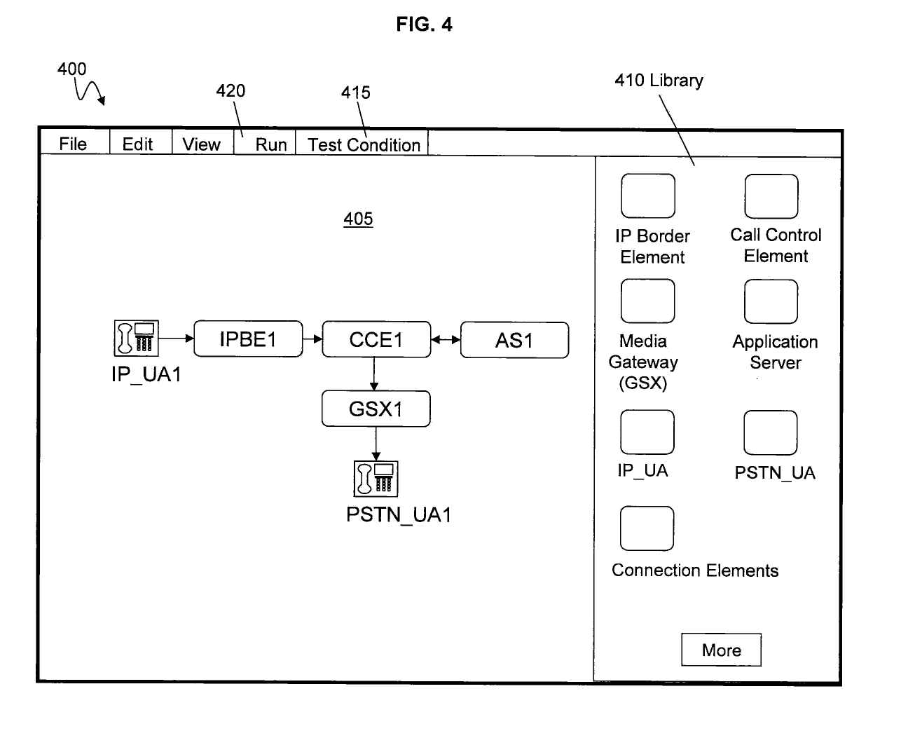

As discussed herein, the application 110 can simulate message and/or call traffic flow in a network including the operation of networking and application layers. For example, via the application 110, the user can utilize the user interface 50 to input a network configuration (which is a network design) made up of the individual network elements (e.g., Internet protocol border element (IPBE) and/or call control element (CCE), etc.). Each element of the application 110 has associated default parameters (or attributes) stored in the database 120 that the user can further define to allow for a more realistic and customizable environment. For example, the application 110 is configured to have default parameters for each network element in the database 120, such as, e.g., default parameters for a service control point (SCP), and the user can add the SCP to a workspace (such as the workspace 405 shown in FIG. 4) and customize the parameters for the SCP by clicking on the SCP. Similarly, to match technical specifications of a particular vendor and/or protocol, the user can adjust and/or define parameters such as IPBE call gapping parameters and the CCE routing parameters in the application 110 for the network design. It is understood that these are just two examples of parameters that may be modified, and there may be others depending on the device and/or network. The application 110 can run the simulation with the default parameters and/or the customized parameters.

In order to execute the simulation, the user utilizes the application 110 to define the initial test case or test condition. The test condition defines how the communication traffic is to flow. For example, the test case can vary from a single call originating from the public switched telephone network (PSTN) to a session initiation protocol (SIP) message exchange between multiple SIP User Agents (e.g., CCE and application servers (AS)). The volume of the test case (i.e., the number and rate of calls and/or registrations) and direction (i.e., outbound, inbound, and platform calls) can also be varied to allow for a wider array of case testing and scenarios. The user can input the direction of the calls (and messages), whether the calls (and messages) are outbound calls, inbound calls, and platform calls. The user can input when the calls occur. For example, in the test case of the application 110, the calls (or any type of communication traffic) can all occur at once from one network elements to another network element, the calls can occur at intervals (e.g., every X milliseconds (ms), X seconds, X minutes, X hours, etc.), the calls can all occur within a time period (e.g., within X milliseconds (ms), X seconds, X minutes, X hours, etc.), the calls can occur in bursts, and/or the calls can be set to any combination

Also, the application 110 is operative to use all of the input information to simulate the communication traffic of messages and/or calls and to generate a graphical representation of the network design. Also, when simulating the communication traffic of messages and/or calls over the created network, the application 110 is operative to output on the display 45 data such as the following:

Volume of communication traffic traversing each network element;

Type and sub-type of traffic traversing each network element, such as, e.g., SIP, H.323 protocols, electronic number mapping (ENUM), etc.;

Link utilization (e.g., what capacity, such as minimal, half, full, exceeded, of the connection, e.g., trunk is being utilized);

Network element (NE) central processing unit (CPU) utilization;

Bandwidth utilization; and

Impacted nodes or nodes susceptible to issues.

Users of application 110 are able to receive an output of the above information displayed on the display 45 to determine any possible network issues such as, e.g., call and message congestion and to determine if the network topology is valid. Further, other network issues determined and displayed on the display 45 by the application 110 may include, e.g., blocked and dropped calls, the prediction of impacts of scheduled maintenance events, link failures, link capacity exceeded, packet delay and loss, and equipment CPU utilization exceeded.

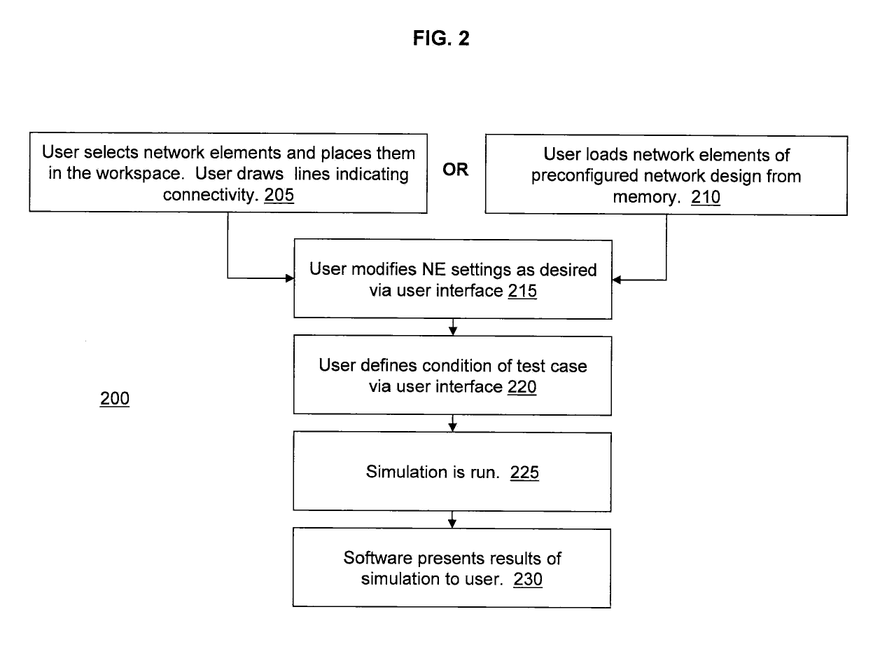

FIG. 2 illustrates a flow chart 200 for creating a network topology (design) for a voice over Internet protocol (VoIP) network in accordance with exemplary embodiments. The example topology illustrated in FIG. 2 is for explanation purposes only and is not meant to be limiting. One skilled in the art understands that the application 110 may be utilized to create and simulate numerous network designs such as, e.g., IMS (IP Multimedia Subsystem) networks, VoIP networks, cellular networks (e.g., general packet radio service (GPRS) core network), and others.

Flow 200 is an example of the user creating a network topology utilizing the application 110 in accordance with exemplary embodiments.

Via the application 110 and the user interface 50, the user selects network elements and places them in the workspace at operation 205. Also, the user utilizes the application 110 to draw lines from one network element to another network element indicating connectivity. That is, the lines represent connection elements in which the communication traffic flows.

Alternatively and/or additionally, the user may load a preconfigured network design from the database 120 stored in memory 25 at operation 210. For example, the user may have utilized the application 110 to previously create a network design with various network elements and various network connections indicated by lines, and stored the network design in the database 120. The user may select the preconfigured network design and the user can utilize the application 110 to modify the preconfigured network design as desired, e.g., to add more network elements, delete network elements, and/or change network connections.

The user may utilize the application 110 to modify the network settings as desired via the user interface 40 at operation 215. For example, the application 110 can be utilized to vary the settings and attributes (such as the parameters for the network elements) depending on the different network elements that have been added to the workspace for the network design. Also, the settings from the saved preconfigured design can be utilized by the application 110.

The application 110 is configured to allow the user to define the condition of the test case for the network design via the user interface at operation 220. For example, utilizing the application 110, the user can test the performance of the network design by simulating X amount of public switched telephone network (PSTN) to IP call attempts and/or any type of communication traffic. As discussed herein, the amount and occurrence of communication traffic can be set for the test condition.

The application 110 is operative to run the simulation of the design utilizing the parameters for the network elements, and the test condition for the test case at operation 225.

The application 110 is operative to present the results of the simulation to the user at operation 230. For example, for a router network element in a network design, the application 110 may display in display 45 that the router directed (routed) X amount of packets of communication traffic, had an X average delay period in routing communication traffic, and/or that the router was inoperable with X amount of communication traffic for a particular network element. Further, the application 110 may display results of the simulation, such as the number of successfully completed calls and/or registrations, the number of blocked calls and/or registrations, the average CPU utilization of the devices (i.e., network elements) of the network design, etc.

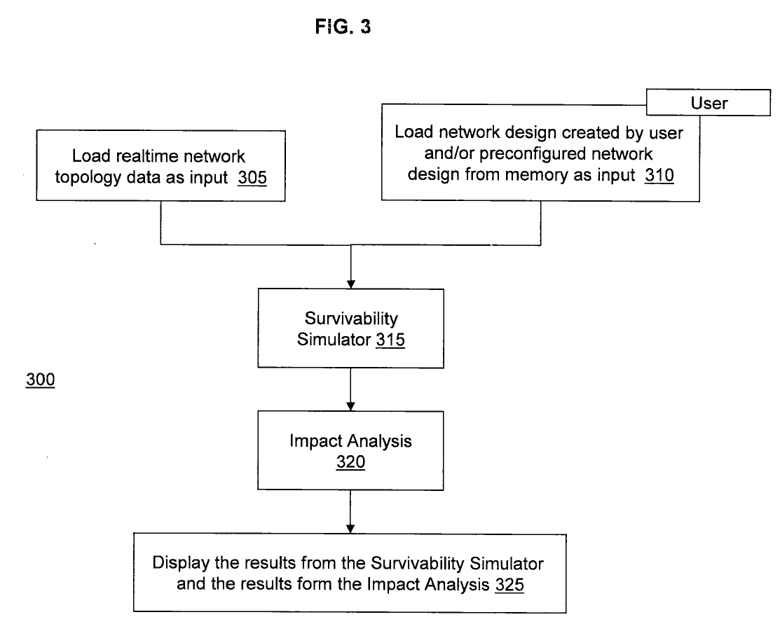

FIG. 3 illustrates a flow chart 300 of simulating the network design by the application 110 in accordance with exemplary embodiments.

The application 110 is operative to load as input realtime network topology data from an actual network at operation 305. For example, the application 110 may receive a feed from a physical router receiving actual communication traffic for routing to other network elements.

Also, the application 110 is operative to load as input a network design created by the user and/or a preconfigured network design from the database 120 at operation 310.

The application 110 is configured to implement a survivability simulator module and the application 110 analyzes the input (e.g., the realtime network topology data and/or the network design created by the user) to determine survivability aspects of the test network design at operation 315.

The application 110 uses the output from survivability simulator module to determine if there are any excessive loads on any network elements and/or links (i.e., connections) during an impact analysis at operation 320. It is understood that the simulator module and the impact analysis module may be integrated software modules of the application 110.

The application 110 is operative to display the results from the survivability simulator and the results from the impact analysis at operation 325.

For example, the survivability simulator of the application 110 may perform calculation of link performance (e.g., link capacity) and network element impacts (e.g., CPU utilization). The impact analysis of the application 110 may determine which links and network elements are affected by the previous calculations. This includes but not is not limited to isolated links, nodes, and/or portions of network that are isolated as well as the creation of excessive load on network elements.

FIG. 4 illustrates an example of a graphical user interface (GUI) 400 of the application 110 in accordance with exemplary embodiments. The GUI 400 includes a workspace 405 in which the network elements may be added by the user from a network element library 410 to be displayed by the application 110. Via the application 110, the user may select network elements from the network element library 410 to create a network design for simulation. The user may also select a preconfigured network design to be loaded and displayed in the workspace 405.

The network element library 410 may comprise numerous representations of network elements, such as IP border elements (IPBE), call control elements (CCE), media gateways (GSX), application servers (AS), customer(s) making/receiving calls from the IP network (IP_UA), customer(s) making/receiving calls from the PSTN (PSTN_UA), routers, service control points (SCP), private branch exchanges (PBX), etc. The network elements may be selected by the user via the user interface 50 and placed (e.g., click and drag) into in any desired location in the workspace 405. For example, to create the VoIP network design in the workspace 405, the user utilizes the application 110 to select the following network elements: an IP border element (IPBE), call control element (CCE), media gateway (GSX), application server (AS), and IP_UA and PSTN_UA to represent the user endpoints.

In the workspace 405, lines represent connections or connection elements, and the user can draw connections by clicking and dragging from one network element to another. Additionally, the user can select a connection element (i.e., a line) from the network element library 410. In the application 110, the user may click on the network element (i.e., the line) in the workspace 405 connecting network elements to indicate the type of connection element, and if the user does not set the type of connection element, a default connection element will be used. In the network design, these connection elements are the links that allow network elements to communicate with other network elements, and these connection elements may be links such as trunks for PSTN, H.323, SIP, Integrated Services Digital Network (ISDN), and/or signaling system 7 (SS7), and wireless connections for 3G mobile networks. Also, the connection elements may be links such as Ethernet, T1, and DSL. The user can select (e.g., click) any connection (i.e., line) in the workspace 405 and adjust parameters for that connection element. In the workspace 405 and/or in the network element library 410, the user can select (click on) any network element to view its parameters (which may be a menu of the parameters for that network element), and the user can make changes to the parameters of the network elements.

In the workspace 405, the user has connected IP_UA1 that represents one or more IP terminals that can place calls, send messages, and transmit audio and video in the network design to the PSTN_UA1. The communication traffic from the IP_UA1 to the PSTN_UA1 has to travel via the IPBE1, CCE1, AS1, and GSX1 to form the VoIP network design shown in the workspace 405.

One the network design is created, the user can set the test condition as discussed herein by selecting the test condition button 415. The test condition of the application 110 can be set to automatically increase in the volume of communication traffic (and successively run the simulation) until a network element fails and/or has an excessive delay (greater than X milliseconds, seconds, minutes, etc.).

The user can select run button 420 to run the simulation of the application 110.

In accordance with exemplary embodiments, the application 110 is operative to provide the user with a graphical and user-friendly approach for network planning and to provide the user with a wide array of testing and configuration possibilities. Also, the application 110 is operative to provide automated network design validation and possible networking improvement output. The application 110 is operative to allow the user to troubleshoot service outage events by simulating network scenarios.

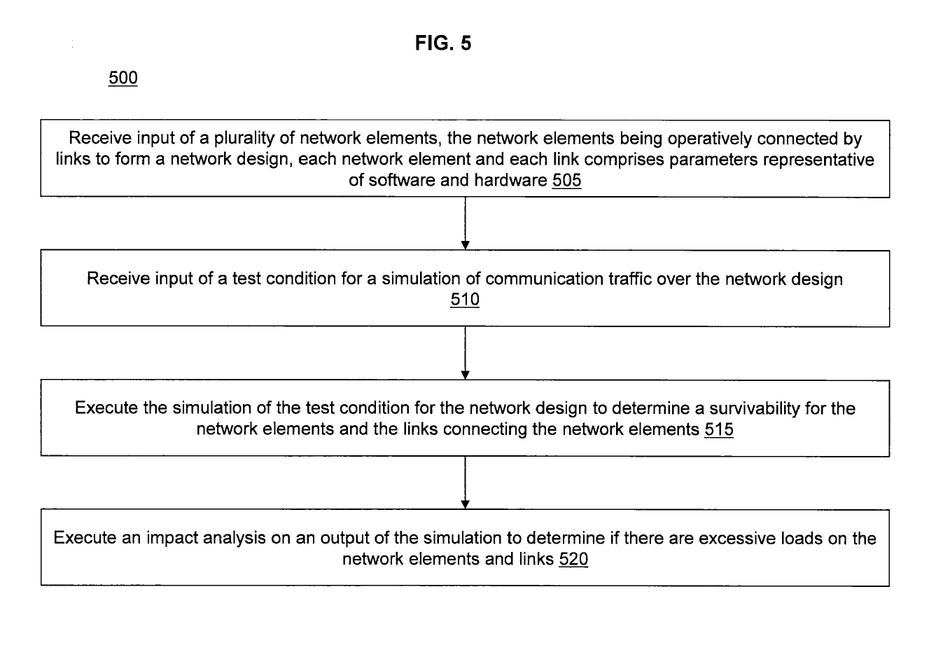

FIG. 5 illustrates a method 500 implemented by the application 110 of the computer 20 for creating and simulating communication traffic over a network design in accordance with exemplary embodiments.

The application 110 is operative to receive input of a plurality of network elements and the network elements operatively connect links to form a network design at operation 505. Each network element and each link includes parameters representative of software and hardware.

The application 110 is operative to receive input of a test condition for a simulation of communication traffic over the network design at operation 510. For example, the test condition may include parameters for a type of communication traffic, an amount of communication traffic, and the various times at which the communication traffic occurs.

The application 110 is operative to execute the simulation of the test condition for the network design to determine a survivability for the network elements and the links connecting the network elements at operation 515.

The application 110 is operative to execute an impact analysis on an output of the simulation to determine if there are excessive loads on the network elements and links at operation 520.

The survivability of the application 110 includes a graphical display of a performance for each network element and each link in the network design and the survivability provides the volume of communication traffic traversing each network element and link. Also, survivability output includes the type of communication traffic traversing each network element and link comprising session initiation protocol (SIP), H.323 protocols, electronic number mapping (ENUM), integrated services digital network (ISDN), and signaling system 7 (SS7), link utilization, network element central processing unit utilization, and bandwidth utilization.

Also, the communication traffic can represent message traffic and call traffic flowing through the network design. When the network design of the application 110 is a voice over Internet protocol (IP) network design that simulates communication traffic between terminals (like telephones, computers, set top boxes, gaming devices, etc.), the terminals are user endpoints of IP terminals and public switched telephone network (PSTN) terminals.

The test condition for the simulation by the application 110 includes a start point and an end point for the communication traffic and the communication traffic flows in the direction from the start point to the end point. Also, the test condition of the application 110 can be configured to have two or more originating points in which communication traffic flows to and from all originating points. In other words, the communication traffic flows in both directions simultaneously to each originating point. Also, in the test condition of the application 110, each originating point may be representative of the source of hundreds (e.g., 100, 200, 300, 400, etc.) of calls and messages to destination originating points. Likewise, each originating point may be representative of the destination of hundreds (e.g., 100, 200, 300, 400, etc.) of calls and messages from source originating points.

Also, in the test condition for the application 110, the amount of communication traffic comprises an amount of messages and calls flowing from start points such as originating points. In the test condition for the application 110, the times at which communication traffic occurs comprises receiving a selection of one or more of the following options: setting communication traffic to occur at a single time; setting communication traffic to occur over a time period; setting communication traffic to occur simultaneously at different bursts over a time period; and setting communication traffic to occur at intervals. For the test condition of the application 110, a combination of all the time settings can be selected and different amounts of communication traffic can be designated for each setting.

It is understood by one skilled in the art that each element such as the devices, servers, software, application, cards, modules, systems, interfaces, adapters, networks, controllers, computers, infrastructure, etc., described in the present disclosure contains all the necessary hardware, software, and/or firmware to operate and function as discussed herein in accordance with exemplary embodiments.

Referring back to FIG. 1, the computer 20 includes, but is not limited to, PCs, workstations, systems, laptops, PDAs, palm devices, servers, mobile devices, communication devices, cell phones, computer systems, set top boxes (STB), televisions (TV), game consoles, MP3 players, and the like. The computer 20 may include processors 60, memory 25, and one or more input and/or output (I/O) devices (or peripherals) that are communicatively coupled via a local interface (not shown). The local interface can be, for example but not limited to, one or more buses or other wired or wireless connections, as is known in the art. The local interface may have additional elements, such as controllers, buffers (caches), drivers, repeaters, and receivers, to enable communications. Further, the local interface may include address, control, and/or data connections to enable appropriate communications among the aforementioned components.

The processor 60 is a hardware device for executing software that can be stored in the memory 25. The processor 60 can be virtually any custom made or commercially available processor, a central processing unit (CPU), a data signal processor (DSP), or an auxiliary processor among several processors associated with the computer 20, and the processor 20 may be a semiconductor based microprocessor (in the form of a microchip) or a macroprocessor.

The memory 25 can include any one or combination of volatile memory elements (e.g., random access memory (RAM, such as dynamic random access memory (DRAM), static random access memory (SRAM), etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.), which may be considered as a computer readable medium. Moreover, the memory 25 may incorporate electronic, magnetic, optical, and/or other types of storage media. Note that the memory 25 can have a distributed architecture, where various components are situated remote from one another, but can be accessed by the processor 60.

The software in the memory 25 may include one or more separate programs, each of which comprises an ordered listing of executable instructions for implementing logical functions. The software in the memory 25 includes a suitable operating system (O/S), compiler, source code, and one or more applications 110 (including the simulator module and impact analysis module) of the exemplary embodiments.

The operating system controls the execution of other computer programs, and provides scheduling, input-output control, file and data management, memory management, and communication control and related services. It is contemplated by the inventors that the application 110 for implementing exemplary embodiments is applicable on all other commercially available operating systems.

The application 110 may be a source program, executable program (object code), script, or any other entity comprising a set of instructions to be performed. When a source program is to be executed, then the program is usually translated via a compiler, assembler, interpreter, or the like, which may or may not be included within the memory, so as to operate properly in connection with the O/S. Furthermore, the application 110 can be written as (a) an object oriented programming language, which has classes of data and methods, or (b) a procedure programming language, which has routines, subroutines, and/or functions, for example but not limited to, C, C++, C#, Pascal, BASIC, API calls, HTML, XHTML, XML, ASP scripts, FORTRAN, COBOL, Perl, Java, ADA, .NET, and the like.

The I/O devices may include input devices such as, for example but not limited to, a mouse, keyboard, scanner, microphone, remote controller, camera, biometric input device(s), a vibrator device for non-audible alert, etc. Furthermore, the I/O devices may also include output devices, for example but not limited to, a printer, display, speaker, etc. Also, the I/O devices may further include devices that communicate both inputs and outputs, for instance but not limited to, a NIC or modulator/demodulator (for accessing remote devices, other files, devices, systems, or a network), a radio frequency (RF) or other transceiver, a telephonic interface, a bridge, a router, etc. The I/O devices include may include modems, gateways, receivers, transmitters, transceivers, etc. for communicating over a communications network.

When the computer 20 is in operation, the processor 60 is configured to execute software stored within the memory 25, to communicate data to and from the memory 25, and to generally control operations of the computer 20 pursuant to the software. The application 110 and the O/S are read, in whole or in part, by the processor 60, perhaps buffered within the processor 60, and then executed.

When the application 110 is implemented in software, it should be noted that the application 110 can be stored on virtually any computer readable storage medium for use by or in connection with any computer related system or method. In the context of this document, a computer readable storage medium may be an electronic, magnetic, optical, or other physical device or means that can contain or store a computer program for use by or in connection with a computer related system or method.

The application 110 can be embodied in any computer-readable storage medium for use by or in connection with an instruction execution system, apparatus, or device, such as a computer-based system, processor-containing system, or other system that can fetch the instructions from the instruction execution system, apparatus, or device and execute the instructions. In the context of this document, computer programs tangibly embodied on a computer-readable storage medium can be stored, communicated, propagated, or transported for use by or in connection with the instruction execution system, apparatus, or device.

More specific examples (a nonexhaustive list) of the computer-readable storage medium would include the following: an electrical connection (electronic) having one or more wires, a portable computer diskette (magnetic or optical), a random access memory (RAM) (electronic), a read-only memory (ROM) (electronic), an erasable programmable read-only memory (EPROM, EEPROM, or Flash memory) (electronic), an optical fiber (optical), and a portable compact disc memory (CDROM, CD R/W) (optical).

In exemplary embodiments, where the application 110 is implemented in hardware, the application 110 can be implemented with any one or a combination of the following technologies, which are each well known in the art: a discrete logic circuit(s) having logic gates for implementing logic functions upon data signals, an application specific integrated circuit (ASIC) having appropriate combinational logic gates, a programmable

As described above, the exemplary embodiments can be in the form of computer-implemented processes and apparatuses for practicing those processes. The exemplary embodiments can also be in the form of computer program code containing instructions embodied in tangible media, such as floppy diskettes, CD ROMs, hard drives, or any other computer-readable storage medium, wherein, when the computer program code is loaded into and executed by a computer such as the computer 1900, the computer becomes an apparatus for practicing the exemplary embodiments. The exemplary embodiments can also be in the form of computer program code, for example, whether stored in a storage medium, loaded into and/or executed by a computer. When the computer program code is loaded into an executed by a computer, the computer becomes an apparatus for practicing the exemplary embodiments. When implemented on a general-purpose microprocessor, the computer program code segments configure the microprocessor to create specific logic circuits. It is understood that computer program code can be transmitted over some transmission medium, loaded into and/or executed by a computer, or transmitted over some transmission medium, such as over electrical wiring or cabling, through fiber optics, or via electromagnetic radiation.

While features have been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the present disclosure without departing from the essential scope thereof. Therefore, it is intended that the present disclosure not be limited to the particular embodiments disclosed for carrying out this invention, but that the invention will include all embodiments falling within the scope of the claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A method implemented on a computer for creating a network design and simulating communication traffic over the network design, comprising:
receiving input of a plurality of network elements, the network elements being operatively connected by links to form a network design, wherein each network element and each link comprises parameters representative of software and hardware;
receiving input of a test condition for a simulation of communication traffic over the network design, the test condition comprising:
a type of communication traffic,
an amount of communication traffic, and
times at which the communication traffic occurs;
executing by a computer the simulation of the test condition for the network design to determine a survivability for the network elements and the links connecting the network elements; and
executing by the computer an impact analysis on an output of the simulation to determine if there are excessive loads on the network elements and links.

2. The method of claim 1, wherein the output of the simulation of the survivability comprises a graphical display of a performance for each network element and each link.

3. The method of claim 1, wherein the output of the simulation of the survivability for the network elements and the link provides:
volume of communication traffic traversing each network element and link;
type of communication traffic traversing each network element and link comprising session initiation protocol (SIP), H.323 protocols, electronic number mapping (ENUM), integrated services digital network (ISDN), and signaling system 7 (SS7);
link utilization;
network element central processing unit utilization; and
bandwidth utilization.

4. The method of claim 1, wherein the communication traffic represents message traffic and call traffic flowing through the network design.

5. The method of claim 1, wherein the network design is a voice over Internet protocol (IP) network design that simulates communication traffic between terminals; and
wherein the terminals are user endpoints of IP terminals and public switched telephone network (PSTN) terminals.

6. The method of claim 1, wherein the network design is a voice over Internet protocol (IP) network design that simulates communication traffic between IP telephones and PSTN telephones.

7. The method of claim 1, wherein the test condition comprises: a start point and an end point for the communication traffic; and
wherein the communication traffic flows in the direction from the start point to the end point.

8. The method of claim 1, wherein the test condition has two originating points in which communication traffic flows to and from both originating points.

9. The method of claim 1, wherein a type of communication traffic comprises at least one of message communication traffic and call communication traffic.

10. The method of claim 1, wherein the amount of communication traffic comprises an amount of messages and calls flowing from start points.

11. The method of claim 1, wherein the times at which communication traffic occurs comprises selecting one or more of the following options:
setting communication traffic to occur at a single time;
setting communication traffic to occur over a time period;
setting communication traffic to occur simultaneously at different bursts over a time period; and
setting communication traffic to occur at intervals.

12. The method of claim 11, wherein all the settings can be selected as a combination; and
wherein different amounts of communication traffic can be designated for each setting.

13. The method of claim 1, wherein an output of the impact analysis displays an indication of each network element and each link that is negatively impacted in the network design.

14. The method of claim 1, wherein based on the communication traffic flowing in the network design, the impact analysis determines and identifies:
network elements which are overloaded;
network elements which are nearing overload;
network elements which have failed;
network elements which are incompatible;
links which are overloaded;
links which have failed; and
links which are nearing overload.

15. A device, comprising:
a program for creating a network design and simulating communication traffic over the network design coupled to memory;
a processor responsive to computer-executable instructions of the software and operative for:
receiving input of a plurality of network elements, the network elements being operatively connected by links to form a network design, wherein each network element and each link comprises parameters representative of software and hardware;
receiving input of a test condition for a simulation of communication traffic over the network design, the test condition comprising:
a type of communication traffic,
an amount of communication traffic, and
times at which the communication traffic occurs;
executing the simulation of the test condition for the network design to determine a survivability for the network elements and the links connecting the network elements; and
executing an impact analysis on an output of the simulation to determine if there are excessive loads on the network elements and links.

16. The device of claim 15, wherein the output of the simulation of the survivability comprises a graphical display of a performance for each network element and each link.

17. The device of claim 15, wherein the output of the simulation of the survivability for the network elements and the link provides:
volume of communication traffic traversing each network element and link;
type of communication traffic traversing each network element and link comprising session initiation protocol (SIP), H.323 protocols, electronic number mapping (ENUM), integrated services digital network (ISDN), and signaling system 7 (SS7);
link utilization;
network element central processing unit utilization; and
bandwidth utilization.

18. The device of claim 15, wherein the communication traffic represents message traffic and call traffic flowing through the network design.

19. The device of claim 15, wherein the network design is a voice over Internet protocol (IP) network design that simulates communication traffic between terminals; and
wherein the terminals are user endpoints of IP terminals and public switched telephone network (PSTN) terminals.

20. A computer program product, tangibly embodied on a computer readable storage medium, the computer program product including instructions for causing a computer to execute a method for creating a network design and simulating communication traffic over the network design, comprising:
receiving input of a plurality of network elements, the network elements being operatively connected by links to form a network design, wherein each network element and each link comprises parameters representative of software and hardware;
receiving input of a test condition for a simulation of communication traffic over the network design, the test condition comprising:
a type of communication traffic,
an amount of communication traffic, and
times at which the communication traffic occurs;
executing the simulation of the test condition for the network design to determine a survivability for the network elements and the links connecting the network elements; and
executing an impact analysis on an output of the simulation to determine if there are excessive loads on the network elements and links.
